(19) United States
(12) Patent Application Publication
(10) Pub. No.: US 2019/0247926 A1
(43) Pub. Date: Aug. 15, 2019

(54) CUTTING INSERT WITH INTERNAL COOLANT PASSAGEWAYS

(71) Applicant: Kennametal Inc., Latrobe, PA (US)

(72) Inventors: Xiangdong D. Fang, Greensboro, PA (US); Ruy Frota de Souza Filho, Latrobe, PA (US); David J. Wills, Greensburg, PA (US)

(73) Assignee: Kennametal Inc., Latrobe, PA (US)

(21) Appl. No.: 15/896,218

(22) Filed: Feb. 14, 2018

(51) Int. Cl. B23B 27/10; B23B 27/16

(52) U.S. Cl. CPC B23B 27/10; B23B 27/16

(57) ABSTRACT

A cutting insert with internal coolant passageways is disclosed. The cutting insert includes at least one internal coolant inlet passageway having a first cross-sectional area, and at least one internal coolant exit passageway having a second cross-sectional area. The at least one internal coolant exit passageway is in fluid communication with the at least one internal coolant inlet passageway. The coolant enters the at least one internal coolant inlet passageway at a first surface of the cutting insert and exits the at least one coolant exit passageway at a second, different surface of the cutting insert. The second cross-sectional area of the at least one internal coolant exit passageway are less than the first cross-sectional area of the at least one internal coolant inlet passageway, thereby producing an increased streaming effect of the coolant to an insert-chip interface.

### BACKGROUND OF THE INVENTION

The invention relates to a cutting insert, which has internal cooling, and an assembly using the cutting insert for use in the removal of material from a workpiece. More specifically, the invention pertains to a cutting insert, as well as an assembly using the cutting insert, used for material removal operations wherein there is increased delivery of coolant adjacent the interface between the cutting insert and the workpiece (i.e., the insert-chip interface) to diminish excessive heat at the insert-chip interface.

In a material removal operation (e.g., a milling operation, a turning operation, and the like), heat is generated at the interface between the cutting insert and the location where the chip is removed from the workpiece (i.e., the insert-chip interface). It is well-known that excessive heat at the insert-chip interface can negatively impact upon (i.e., reduce or shorten) the useful tool life of the cutting insert. As can be appreciated, a shorter useful tool life increases operating costs and decreases overall production efficiency. Hence, there are readily apparent advantages connected with decreasing the heat at the insert-chip interface.

It is readily apparent that in a material removal operation, higher operating temperatures at the insert-chip interface can have a detrimental impact on the useful tool life through premature breakage and/or excessive wear. It would be highly desirable to provide a cutting insert used for material removal operations wherein there is an improved delivery of coolant to the interface between the cutting insert and the workpiece (i.e., the insert-chip interface), which is the location on the workpiece where the chip is generated). There would be a number of advantages connected with the improved delivery of coolant to the insert-chip interface.

In a material removal operation, the chip generated from the workpiece can sometimes stick (e.g., through welding) to the surface of the cutting insert. The build-up of chip material on the cutting insert in this fashion is an undesirable occurrence that can negatively impact upon the performance of the cutting insert, and hence, the overall material removal operation. It would be highly desirable to provide a cutting insert used for material removal operations wherein there is increased delivery of coolant to the insert-chip interface so as to result in increased lubrication at the insert-chip interface. The consequence of increased lubrication at the insert-chip interface is a decrease in the tendency of the chip to stick to the cutting insert.

### SUMMARY OF THE INVENTION

In one form thereof, the invention is a cutting insert that is useful in removing material from a workpiece. The cutting insert includes a cutting insert body, which includes a cutting edge having at least one discrete cutting location. The cutting insert body further contains a distinct interior coolant passage communicating with the discrete cutting location. The distinct interior coolant passage has a coolant passage inlet defining a coolant passage inlet cross-sectional area, a coolant passage discharge defining a coolant passage discharge cross-sectional area, and an axial coolant passage length. The distinct interior coolant passage defines a coolant flow cross-sectional area along the axial coolant passage length thereof. The coolant passage inlet cross-sectional area is substantially the same as the coolant passage discharge cross-sectional area. The geometry of the coolant flow cross-sectional area changes along the axial coolant passage length.

In another form thereof, the invention is a cutting insert includes at least one internal coolant inlet passageway having a first cross-sectional area, and at least one internal coolant exit passageway having a second cross-sectional area. The at least one internal coolant exit passageway is in fluid communication with the at least one internal coolant inlet passageway. The coolant enters the at least one internal coolant inlet passageway at a first surface of the cutting insert and exits the at least one coolant exit passageway at a second, different surface of the cutting insert. The second cross-sectional area of the at least one internal coolant exit passageway is less than the first cross-sectional area of the at least one internal coolant inlet passageway, thereby producing an increased streaming effect of the coolant to an insert-chip interface.

In yet another form thereof, the invention is a cutting insert comprising a plurality of internal coolant passageways, each internal coolant passageway comprising a circular coolant inlet passageway and a circular coolant exit passageway, wherein a diameter of each circular coolant exit passageway is at least two times less than a diameter of the circular coolant inlet passageway, thereby producing an increased streaming effect of the coolant to an insert-chip interface.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1A is a front perspective view of a cutting insert, such as a drill head, according to an embodiment of the invention;

FIG. 1B is a front view of the cutting insert of FIG. 1A;

FIG. 1C is a cross-sectional view of the cutting insert taken along line H-H of FIG. 1B;

FIG. 2A is a front perspective view of a cutting insert, such as a drill head, according to an embodiment of the invention;

FIG. 2B is a front view of the cutting insert of FIG. 2A;

FIG. 2C is a cross-sectional view of the cutting insert taken along folded section line K-K of FIG. 2B;

FIG. 3A is a front perspective view of a cutting insert, such as a drill head, according to an embodiment of the invention;

FIG. 3B is a front view of the cutting insert of FIG. 3A;

FIG. 3C is a cross-sectional view of the cutting insert taken along folded section line M-M of FIG. 3B;

FIG. 4A is a front perspective view of a cutting insert, such as a drill head, according to an embodiment of the invention;

FIG. 4B is a front view of the cutting insert of FIG. 4A;

FIG. 4C is a cross-sectional view of the cutting insert taken along folded section line P-P of FIG. 4B;

FIG. 5A is a front perspective view of a cutting insert, such as a milling cutting insert, according to an embodiment of the invention;

FIG. 5B is a front view of the cutting insert of FIG. 5A;

FIG. 5C is a cross-sectional view of the cutting insert taken along line D-D of FIG. 5B;

FIG. 6A is a front perspective view of a cutting insert, such as a milling cutting insert, according to an embodiment of the invention;

FIG. 6B is a front view of the cutting insert of FIG. 6A;

FIG. 6C is a cross-sectional view of the cutting insert taken along line E-E of FIG. 6B;

FIG. 7A is a front perspective view of a compound cutting insert, such as a milling cutting insert, according to an embodiment of the invention;

FIG. 7B is a front view of the compound cutting insert of FIG. 7A;

FIG. 7C is a cross-sectional view of the compound cutting insert taken along line C-C of FIG. 7B; and

FIG. 7D is a cross-sectional view of the compound cutting insert taken along line D-D of FIG. 7B.

### DETAILED DESCRIPTION OF THE INVENTION

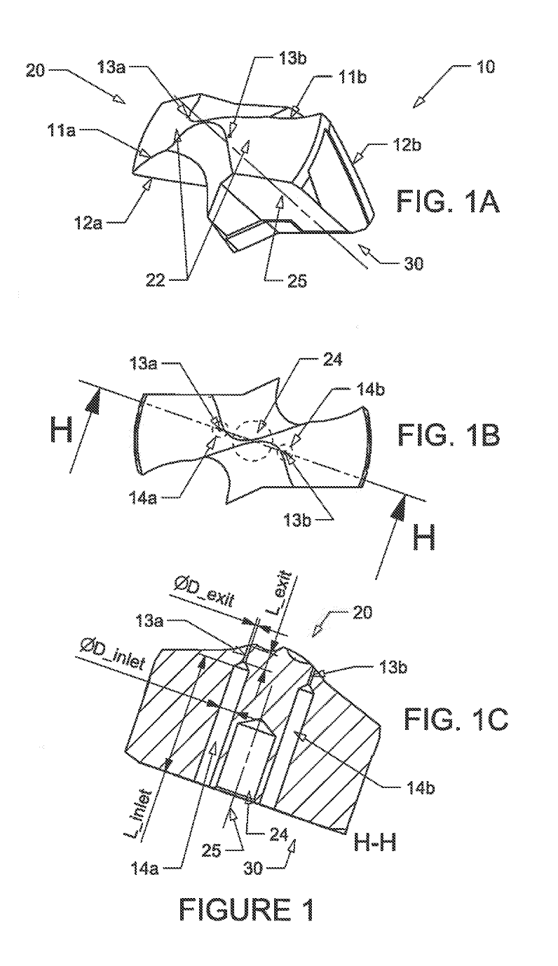

Referring to FIGS. 1A-1C, a cutting insert 10 is shown according to an embodiment of the invention. In the material removal operation, the cutting insert 10 engages a workpiece to remove material from a workpiece (not shown) typically in the form of chips, wherein a coolant source (not shown) supplies pressurized gaseous coolant to the cutting insert, such as air, CO₂, and the like, to the insert-chip interface. A material removal operation that removes material from the workpiece in the form of chips typically is known by those skilled in the art as a material removal operation.

The cutting insert 10 may be made from one of any number of materials that are suitable for use as a cutting insert. The following materials are exemplary materials useful for a cutting insert: tool steels, cemented carbides, cermets or ceramics. The specific materials and combinations of materials depend upon the specific application for the cutting insert. Applicants contemplate that the cutting insert 10 may be made from one or more different materials. In the illustrated embodiment, the cutting insert 10 is made of carbide material.

In reference to tool steels, the following patent documents disclose tool steels suitable for use as a cutting insert: U.S. Pat. No. 4,276,085 for High Speed Steel, U.S. Pat. No. 4,880,461 for Superhard high-speed tool steel, and U.S. Pat. No. 5,252,119 for High Speed Tool Steel Produced by Sintered Powder and Method of Producing the Same. In reference to cemented carbides, the following patent documents disclose cemented carbides suitable for use as a cutting insert: U.S. Patent Application Publication No. US2006/0171837 A1 for a Cemented Carbide Body Containing Zirconium and Niobium and Method of Making the Same, U.S. Reissue Pat. No. 34,180 for Preferentially Binder Enriched Cemented Carbide Bodies and Method of Manufacture, and U.S. Pat. No. 5,955,186 for a Coated Cutting Insert with A C Porosity Substrate Having Non-Stratified Surface Binder Enrichment. In reference to cermets, the following patent documents disclose cermets suitable for use as a cutting insert: U.S. Pat. No. 6,124,040 for Composite and Process for the Production Thereof, and U.S. Pat. No. 6,010,283 for a Cutting Insert of a Cermet Having a Co—Ni—Fe Binder. In reference to ceramics, the following patent documents disclose ceramics suitable for use as a cutting insert: U.S. Pat. No. 5,024,976 for an Alumina-zirconia-silicon carbide-magnesia Ceramic Cutting Tools, U.S. Pat. No. 4,880,755 for a SiAlON Cutting Tool Composition, U.S. Pat. No. 5,525,134 for a silicon Nitride Ceramic and Cutting Tool made Thereof, U.S. Pat. No. 6,905,992 for a Ceramic Body Reinforced with Coarse Silicon Carbide Whiskers and Method for Making the Same, and U.S. Pat. No. 7,094,717 for a SiAlON Containing Ytterbium and Method of Making.

There should be an appreciation that the cutting insert 10 of the invention can operate in a number of different applications. The cutting insert, which has internal coolant delivery, is for use in the removal of material from a workpiece. In this respect, the cutting insert is for use in a material removal operation, wherein there is increased delivery of coolant to the entire cutting insert to diminish excessive heat at the interface between the cutting insert and the workpiece (i.e., the insert-chip interface).

The increased delivery of coolant to the insert-chip interface leads to certain advantages. For example, increased delivery of coolant to the insert-chip interface results in increased lubrication at the insert-chip interface which decreases the tendency of the chip to stick to the cutting insert. Further, increased flow of coolant to the insert-chip interface leads to better evacuation of chips from the vicinity of the interface with a consequent reduction in the potential to re-cut a chip.

The description herein of specific applications should not be a limitation on the scope and extent of the use of the drill head or cutting insert.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Throughout the text and the claims, use of the word “about” in relation to a range of values (e.g., “about 22 to 35 wt %”) is intended to modify both the high and low values recited, and reflects the penumbra of variation associated with measurement, significant figures, and interchangeability, all as understood by a person having ordinary skill in the art to which this invention pertains.

For purposes of this specification (other than in the operating examples), unless otherwise indicated, all numbers expressing quantities and ranges of ingredients, process conditions, etc are to be understood as modified in all instances by the term “about”. Accordingly, unless indicated to the contrary, the numerical parameters set forth in this specification and attached claims are approximations that can vary depending upon the desired results sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements including that found in the measuring instrument. Also, it should be understood that any numerical range recited herein is intended to include all sub-ranges subsumed therein. For example, a range of “1 to 10” is intended to include all sub-ranges between and including the recited minimum value of 1 and the recited maximum value of 10, i.e., a range having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

As used herein, “compound article” or “compound cutting insert” refers to an article or cutting insert having discrete portions, which may or may not differ in physical properties, chemical properties, chemical composition and/or microstructure. These portions do not include mere coatings applied to an article or insert. The difference in material properties, if they exist, may result in the portions differing with respect to at least one characteristic, which may be at least one of, for example, hardness, tensile strength, wear resistance, fracture toughness, modulus of elasticity, corrosion resistance, coefficient of thermal expansion, and coefficient of thermal conductivity. Compound inserts that may be constructed as provided in the present invention include inserts, for example, turning, cutting, slotting, milling, drilling, reaming, countersinking, counterboring, end milling, and tapping of materials.

It should be noted that the “compound article” or “compound cutting insert” of the present invention differs from a “composite material,” which is a material that is a composite of two or more phases, for example, a ceramic component in a binder, such as a cemented carbide.

In general, the cutting insert 10 may be a modular drill blade, a replaceable drill head, a drilling insert, a milling cutting insert, a turning cutting insert, a boring cutting insert, a threading cutting insert, or a cut-off cutting insert. In the illustrated embodiment, the cutting insert comprises a drill head for a rotary cutting tool (not shown). The drill head 10 includes a front end 20, a rear end 30 opposite the front end 20, a front clearance face 22, one or more primary cutting edges 11a, 11b, and one or more secondary cutting edges 12a, 12b. The drill head 10 also includes one or more coolant exit passageways 13a, 13b, and one or more coolant inlet passageways 14a, 14b in fluid communication with the one or more coolant exit passageways 13a, 13b for the increased delivery of pressurized gaseous coolant, such as air, Supercritical Fusion CO₂, and the like, to the insert-chip interface. It should be an appreciation that any one of a number of different kinds of gaseous fluids or coolants are suitable for use in the cutting insert 10 of the invention.

It will be appreciated that the one or more coolant exit passageways 13a, 13b can have a uniform or constant cross-sectional shape or a non-uniform or varying cross-sectional shape. For example, the one or more coolant exit passageways 13a, 13b may have a gradually varying cross-sectional area along the entire length of their coolant exit passageways. In other words, each coolant exit passageway 13a, 13b has a tapered shape or a draft angle along the longitudinal axis of its coolant exit passageway. As an example, for a coolant exit passageway having a circular cross-sectional area, the shape of the coolant exit passageway 13a, 13b may have an internal cone shape, a tapered internal cylindrical shape, and the like.

In the illustrated embodiment, the one or more coolant exit passageways 13a, 13b and the one or more coolant inlet passageways 14a, 14b are substantially circular in cross-sectional shape. However, it should be appreciated that the invention is not limited by the cross-sectional shape of the coolant exit passageways 13a, 13b and the coolant inlet passageways 14a, 14b, and that the invention can be practiced with any desirable cross-sectional shape for effective coolant delivery. For example, the coolant exit passageways 13a, 13b and the coolant inlet passageways 14a, 14b can have any polygonal cross-sectional shape, for example, a triangle, rectangle, pentagram, hexagram, and the like. Similarly, the cross-sectional shape of the coolant exit passageways 13a, 13b can be different than the cross-section shape of the coolant inlet passageways 14a, 14b. The drill head 10 also includes a locating pin hole 24 for assisting in properly locating the drill head 10 when mounting the drill head 10 to a support member (not shown) of the rotary cutting tool. In operation, the drill head 10 rotates about a central, rotational axis 25.

One aspect of the invention is that each of the one or more coolant exit passageways 13a, 13b have different dimensions (i.e., diameter and length) than each of the one or more coolant inlet passageways 14a, 14b. Specifically, the coolant exit passageway 13a has an outer diameter, OD_exit, that is less than an outer diameter, OD_inlet, of the coolant inlet passageway 14a, which increases the pressure and velocity of the coolant as the coolant passes through the cutting insert 10. In other words, the cross-sectional area of the coolant exit passageway 13a is less than the cross-sectional area of the coolant inlet passageway 14a. Similarly, the coolant exit passageway 13b has an outer diameter, OD_exit, that is less than an outer diameter, OD_inlet, of the coolant inlet passageway 14b. In one embodiment, the outer diameter, OD_exit, of the coolant exit passageways 13a, 13b is in a range between about 0.10 mm to about 1.00 mm. In one embodiment, for example, the range of the outer diameter, OD_exit, of the coolant exit passageways 13a, 13b is between about 0.15 mm to about 0.30 mm.

In one embodiment, the coolant exit passageways 13a, 13b have an outer diameter, OD_exit, that is at least two times smaller than an outer diameter, OD_inlet, of the coolant inlet passageways 14a, 14b. In another embodiment, the coolant exit passageways 13a, 13b have an outer diameter, OD_exit, that is at least three times smaller than an outer diameter, OD_inlet, of the coolant inlet passageways 14a, 14b. In yet another embodiment, the coolant exit passageways 13a, 13b have an outer diameter, OD_exit, that is at least five times smaller than an outer diameter, OD_inlet, of the coolant inlet passageways 14a, 14b. In still yet another embodiment, the coolant exit passageways 13a, 13b have an outer diameter, OD_exit, that is at least ten times smaller than an outer diameter, OD_inlet, of the coolant inlet passageways 14a, 14b. In other words, in the case where the coolant exit passageways 13a, 13b and the coolant inlet passageways 14a, 14b are circular in cross-sectional shape, the coolant exit passageways 13a, 13b have an outer diameter, OD_exit, that is at least 2-10 times smaller than an outer diameter, OD_inlet, of the coolant inlet passageways 14a, 14b.

In addition, the coolant exit passageway 13a has a length, L_exit, that is less than a length, L_inlet, of the coolant inlet passageway 14a. Similarly, the coolant exit passageway 13b has a length, L_exit, that is less than a length, L_inlet, of the coolant inlet passageway 14b. In the illustrated embodiment, the length, L_exit, of the coolant exit passageways 13a, 13b are substantially identical to each other. However, it will be appreciated that the invention can be practiced with one or more coolant exit passageways 13a, 13b have a length, L_exit, that is different with respect to one or more coolant exit passageways 13a, 13b.

In one embodiment, the coolant exit passageways 13a, 13b have a length, L_exit, that is at least two times smaller than a length, L_inlet, of the coolant inlet passageways 14a, 14b. In another embodiment, the coolant exit passageways 13a, 13b have a length, L_exit, that is at least three times smaller than a length, L_inlet, of the coolant inlet passageways 14a, 14b. In yet another embodiment, the coolant exit passageways 13a, 13b have a length, L_exit, that is at least five times smaller than a length, L_inlet, of the coolant inlet passageways 14a, 14b. In still yet another embodiment, the coolant exit passageways 13a, 13b have a length, L_exit, that is at least ten times smaller than a length, L_inlet, of the coolant inlet passageways 14a, 14b. In other words, the coolant exit passageways 13a, 13b have a length, L_exit, that is at least 2-10 times less than the length, L_inlet, of the coolant inlet passageways 14a, 14b.

In the illustrated embodiment, the outer diameter, OD_exit, of the coolant exit passageways 13a, 13b are substantially identical to each other, and the outer diameter, OD_inlet, of the coolant inlet passageways 14a, 14b are substantially identical to each other. However, it will be appreciated that the outer diameter, OD_exit, of one or more of the coolant exit passageways 13a, 13b may have a different diameter with respect to the other coolant exit passageways 13a, 13b. Likewise, the outer diameter, OD_inlet, of one or more of the coolant inlet passageways 14a, 14b may be different, so long as each of the coolant exit passageways 13a, 13b have a smaller outer diameter than the coolant inlet passageways 14a, 14b.

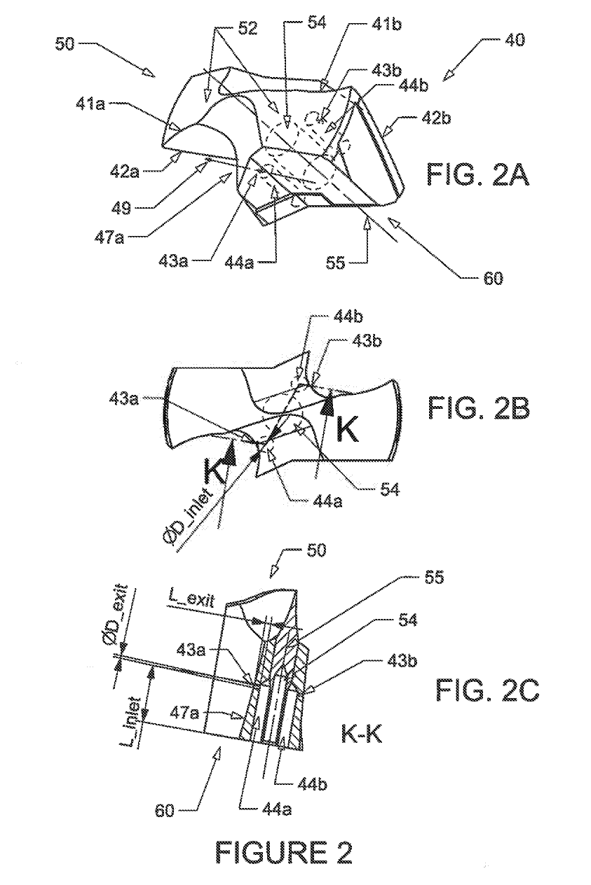

Referring now to FIGS. 2A-2C, a cutting insert 40 is shown according to another embodiment of the invention. In general, the cutting insert 40 comprises a drill head for a rotary cutting tool (not shown). The drill head 40 includes a front end 50, a rear end 60 opposite the front end 50, a front clearance face 62, a side clearance face 47a, one or more primary cutting edges 41a, 41b, and one or more secondary cutting edges 42a, 42b. The cutting insert 40 also includes one or more coolant exit passageways 43a, 43b, and one or more coolant inlet passageways 44a, 44b in fluid communication with the one or more coolant exit passageways 43a, 43b for the increased delivery of pressurized gaseous coolant, such as air, CO₂, and the like, to the insert-chip interface. In this embodiment, the coolant exit passageways 43a, 43b extend internally from a respective coolant inlet passageway 44a, 44b to the side clearance face 47a of the drill head 40, and the one or more coolant inlet passageways 44a, 44b extend internally from the rear end 60 of the drill head 40 substantially parallel to the central, rotational axis 55 toward the front end 50.

In the illustrated embodiment, the one or more coolant exit passageways 43a, 43b and the one or more coolant inlet passageways 44a, 44b are substantially circular in cross-sectional shape. However, it should be appreciated that the invention is not limited by the cross-sectional shape of the coolant exit passageways 43a, 43b and the coolant inlet passageways 44a, 44b, and that the invention can be practiced with any desirable cross-sectional shape for effective delivery of coolant to the insert-chip interface. For example, the coolant exit passageways 43a, 43b and the coolant inlet passageways 44a, 44b can have any polygonal cross-sectional shape. In addition, the cross-sectional shape of the coolant exit passageways 43a, 43b can be different than the cross-section shape of the coolant inlet passageways 44a, 44b. The drill head 40 also includes a locating pin hole 54 (shown as dashed lines in FIGS. 2A and 2B) for assisting in properly locating the drill head 40 when mounting the drill head 40 to a support member (not shown) of the rotary cutting tool. In operation, the drill head 40 rotates about a central, rotational axis 55.

Similar to the drill head 10, each of the one or more coolant exit passageways 43a, 43b of the drill head 40 have different dimensions (i.e., diameter and length) than each of the one or more coolant inlet passageways 44a, 44b. Specifically, the coolant exit passageway 43a has an outer diameter, OD_exit, that is less than an outer diameter, OD_inlet, of the coolant inlet passageway 44a. Similarly, the coolant exit passageway 43b has an outer diameter, OD_exit, that is less than an outer diameter, OD_inlet, of the coolant inlet passageway 44b. In one embodiment, the outer diameter, OD_exit, of the coolant exit passageways 43a, 43b is in a range between about 0.10 mm to about 1.00 mm. In another embodiment, for example, the range of the outer diameter, OD_exit, of the coolant exit passageways 43a, 43b is between about 0.20 mm to about 0.40 mm. In yet another embodiment, for example, the range of the outer diameter, OD_exit, of the coolant exit passageways 43a, 43b is between about 0.15 mm to about 0.30 mm.

In addition, the coolant exit passageway 43a has a length, L_exit, that is less than a length, L_inlet, of the coolant inlet passageway 44a. Similarly, the coolant exit passageway 43b has a length, L_exit, that is less than a length, L_inlet, of the coolant inlet passageway 44b. In the illustrated embodiment, the length, L_exit, of the coolant exit passageways 43a, 43b are substantially identical to each other. However, it will be appreciated that the invention can be practiced with one or more coolant exit passageways 43a, 43b have a length, L_exit, that is different with respect to one or more coolant exit passageways 43a, 43b.

In the illustrated embodiment, the outer diameter, OD_exit, of the coolant exit passageways 43a, 43b are substantially identical to each other, and the outer diameter, OD_inlet, of the coolant inlet passageways 44a, 44b are substantially identical to each other. However, it will be appreciated that the outer diameter, OD_exit, of one or more of the coolant exit passageways 43a, 43b may have a different diameter with respect to the other coolant exit passageways 43a, 43b. Likewise, the outer diameter, OD_inlet, of one or more of the coolant inlet passageways 44a, 44b may be different, so long as each of the coolant exit passageways 43a, 43b have a smaller outer diameter than the coolant inlet passageways 44a, 44b.

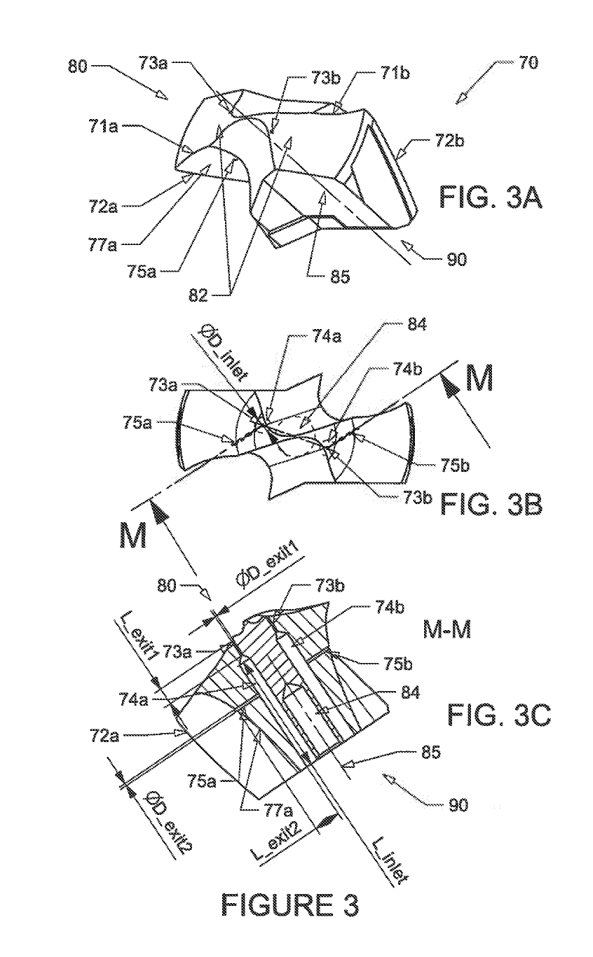

Referring now to FIGS. 3A-3C, a cutting insert 70 is shown according to another embodiment of the invention. In general, the cutting insert 70 comprises a drill head for a rotary cutting tool (not shown). The drill head 70 includes a front end 80, a rear end 90 opposite the front end 80, a front clearance face 82, a side clearance face 77a, one or more primary cutting edges 71a, 71b, and one or more secondary cutting edges 72a, 72b. The cutting insert 70 also includes one or more coolant exit passageways 73a, 73b, 75a, 75b, and one or more coolant inlet passageways 74a, 74b in fluid communication with the one or more coolant exit passageways 73a, 73b, 75a, 75b for the increased delivery of pressurized gaseous coolant, such as air, CO₂, and the like, to the insert-chip interface. In this embodiment, the one or more coolant exit passageways 73a, 73b extend internally from a respective coolant inlet passageway 74a, 74b to the front clearance face 82 of the drill head 70, and the one or more coolant exit passageways 75a, 75b extend internally from a respective coolant inlet passageway 74a, 74b to the side clearance face 77a. Similar to the drill heads 10, 40, the coolant inlet passageways 74a, 74b are located on the rear end 90 and extend internally within the drill head 70 substantially parallel to the central, rotational axis 85 toward the front end 80.

In the illustrated embodiment, the one or more coolant exit passageways 73a, 73b, 75a, 75b and the one or more coolant inlet passageways 74a, 74b are substantially circular in cross-sectional shape. However, it should be appreciated that the invention is not limited by the cross-sectional shape of the coolant exit passageways 73a, 73b, 75a, 75b and the coolant inlet passageways 74a, 74b, and that the invention can be practiced with any desirable cross-sectional shape for effective delivery of coolant to the insert-chip interface. For example, the coolant exit passageways 73a, 73b, 75a, 75b and the coolant inlet passageways 74a, 74b can have any polygonal cross-sectional shape. In addition, the cross-sectional shape of the coolant exit passageways 73a, 73b, 75a, 75b can be different than the cross-section shape of the coolant inlet passageways 74a, 74b. The drill head 70 also includes a locating pin hole 84 (shown as dashed lines in FIGS. 3A and 3B) for assisting in properly locating the drill head 70 when mounting the drill head 70 to a support member (not shown) of the rotary cutting tool. In operation, the drill head 70 rotates about a central, rotational axis 85.

Similar to the drill heads 10 and 40, each of the one or more coolant exit passageways 73a, 73b, 75a, 75b of the drill head 70 have different dimensions (i.e., diameter and length) than each of the one or more coolant inlet passageways 74a, 74b. Specifically, the coolant exit passageway 73a has an outer diameter, OD_exit, that is less than an outer diameter, OD_inlet, of the coolant inlet passageway 74a. Similarly, the coolant exit passageway 73b has an outer diameter, OD_exit, that is less than an outer diameter, OD_inlet, of the coolant inlet passageway 74b. In one embodiment, the outer diameter, OD_exit, of the coolant exit passageways 73a, 73b, 75a, 75b is in a range between about 0.10 mm to about 1.00 mm. In one embodiment, for example, the range of the outer diameter, OD_exit, of the coolant exit passageways 73a, 73b, 75a, 75b is between about 0.15 mm to about 0.30 mm.

In addition, the coolant exit passageway 73a has a length, L_exit1, that is less than a length, L_inlet, of the coolant inlet passageway 74a, and the coolant exit passageway 75a has a length, L_exit2, that is less than the length, L_inlet, of the coolant inlet passageway 74a. Similarly, the coolant exit passageway 73b has a length, L_exit1, that is less than a length, L_inlet, of the coolant inlet passageway 74b, and the coolant exit passageway 75b has a length, L_exit2, that is less than the length, L_inlet, of the coolant inlet passageway 74b. In the illustrated embodiment, the length, L_exit1, of the coolant exit passageways 73a, 73b are substantially identical to each other, and the length, L_exit2, of the coolant exit passageways 75a, 75b are substantially identical to each other. However, it will be appreciated that the invention can be practiced with one or more coolant exit passageways 73a, 73b having a length that is different with respect to one or more coolant exit passageways 73a, 73b located on the front clearance face 82, and one or more coolant exit passageways 75a, 75b located on the side clearance face 72b having a length that is different with respect to one or more coolant exit passageways 75a, 75b.

In the illustrated embodiment, the outer diameter, OD_exit, of the coolant exit passageways 73a, 73b, 75a, 75b are substantially identical to each other, and the outer diameter, OD_inlet, of the coolant inlet passageways 74a, 74b are substantially identical to each other. However, it will be appreciated that the outer diameter, OD_exit, of one or more of the coolant exit passageways 73a, 73b, 75a, 75b may have a different diameter with respect to the other coolant exit passageways 73a, 73b, 75a, 75b. Likewise, the outer diameter, OD_inlet, of one or more of the coolant inlet passageways 74a, 74b may be different, so long as each of the coolant exit passageways 73a, 73b, 75a, 75b have a smaller outer diameter than the coolant inlet passageways 74a, 74b.

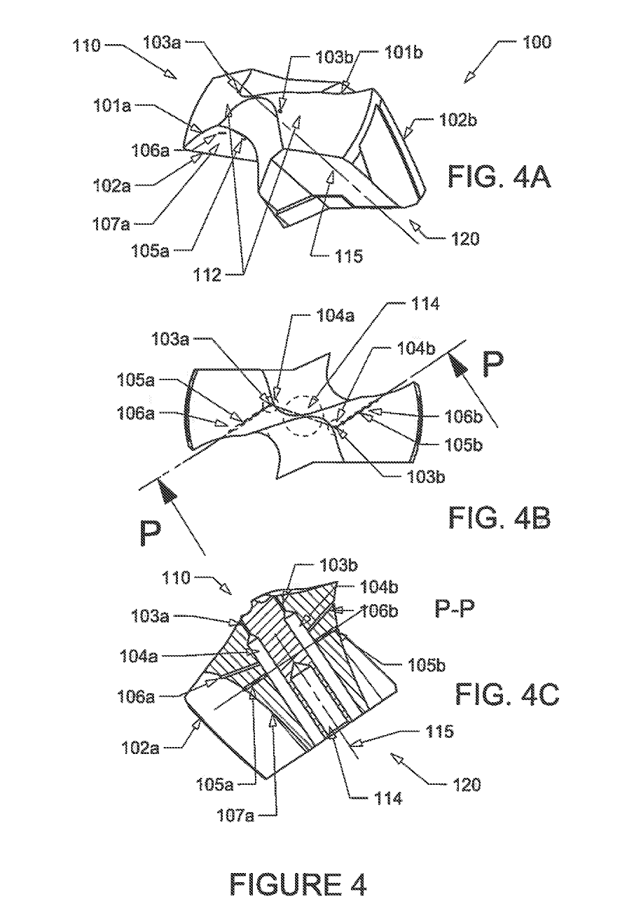

Referring now to FIGS. 4A-4C, a cutting insert 100 is shown according to another embodiment of the invention. In general, the cutting insert 100 comprises a drill head for a rotary cutting tool (not shown). The drill head 100 includes a front end 110, a rear end 120 opposite the front end 110, a front clearance face 112, a side clearance face 107a, one or more primary cutting edges 101a, 101b, and one or more secondary cutting edges 102a, 102b. The cutting insert 100 also includes one or more coolant exit passageways 103a, 103b, 105a, 105b, 106a, 106b and one or more coolant inlet passageways 104a, 104b for the increased delivery of pressurized gaseous coolant, such as air, CO₂, and the like, to the insert-chip interface. In this embodiment, the one or more coolant exit passageways 103a, 103b extend from a respective coolant inlet passageway 104a, 104b to the front clearance face 112 of the drill head 100, and one or more coolant exit passageways 105a, 105b, 106a, 106b extend from a respective coolant inlet passageway 104a, 104b to the side clearance face 107a of the drill head 100. Similar to the drill heads 10, 40, and 70, the coolant inlet passageways 104a, 104b are located at the rear end 120 and extend internally within the drill head 100 substantially parallel to the central, rotational axis 115 toward the front end 110.

In the illustrated embodiment, the one or more coolant exit passageways 103a, 103b, 105a, 105b, 106a, 106b and the one or more coolant inlet passageways 104a, 104b are substantially circular in cross-sectional shape. However, it should be appreciated that the invention is not limited by the cross-sectional shape of the coolant exit passageways 103a, 103b, 105a, 105b, 106a, 106b and the coolant inlet passageways 104a, 104b, and that the invention can be practiced with any desirable cross-sectional shape for effective delivery of coolant to the insert-chip interface. For example, the coolant exit passageways 103a, 103b, 105a, 105b, 106a, 106b and the coolant inlet passageways 104a, 104b can have any polygonal cross-sectional shape. In addition, the cross-sectional shape of the coolant exit passageways 103a, 103b, 105a, 105b, 106a, 106b can be different than the cross-section shape of the coolant inlet passageways 104a, 104b. The drill head 100 also includes a locating pin hole 114 (shown as dashed lines in FIG. 4B) for assisting in properly locating the drill head 100 when mounting the drill head 100 to a support member (not shown) of the rotary cutting tool. In operation, the drill head 100 rotates about a central, rotational axis 115.

Similar to the drill heads 10, 40 and 70, each of the one or more coolant exit passageways 103a, 103b, 105a, 105b, 106a, 106b of the drill head 100 may have different dimensions (i.e., diameter and length) than each of the one or more coolant inlet passageways 104a, 104b. Specifically, the coolant exit passageways 103a, 103b, 105a, 105b, 106a, 106b may have an outer diameter that is less than an outer diameter of the coolant inlet passageways 104a,104b. In one embodiment, the outer diameter of the coolant exit passageways 103a, 103b, 105a, 105b, 106a, 106b is in a range between about 0.10 mm to about 1.00 mm. In one embodiment, for example, the outer diameter of the coolant exit passageways 103a, 103b, 105a, 105b, 106a, 106b is the range between about 0.15 mm to about 0.30 mm.

Similar to the drill heads 10, 40 and 70, the length of each coolant exit passageway 103a, 103b, 105a, 105b, 106a, 106b is less than the length of the coolant inlet passageways 104a, 104b. In the illustrated embodiment, the length of the coolant exit passageways 103a, 103b are substantially identical to each other, the length of the coolant exit passageways 105a, 105b are substantially identical to each other, and the length of the coolant exit passageways 106a, 106b are substantially identical to each other. However, it will be appreciated that the invention can be practiced with one or more coolant exit passageways having a length that is different with respect to one or more other coolant exit passageways. Likewise, the coolant exit passageways 103a, 103b, 105a, 105b, 106a, 106b can have different diameters.

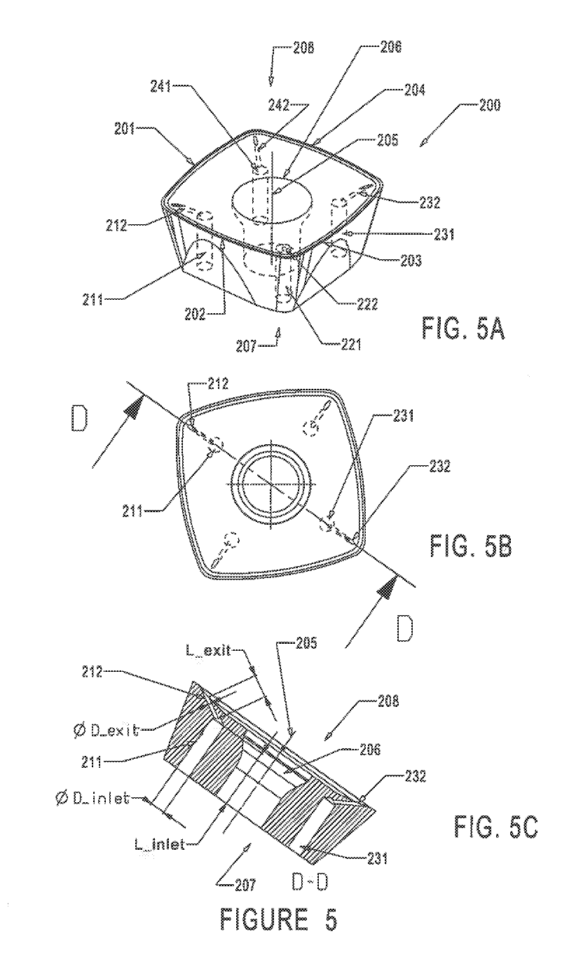

Referring now to FIGS. 5A-5C, a cutting insert 200 is shown according to another embodiment of the invention. In general, the cutting insert 200 comprises a milling cutting insert for a rotary cutting tool (not shown), such as a milling cutter, and the like. The cutting insert 200 includes a top side 208, a bottom side 207 opposite the top side 208, and one or more indexable cutting edges 201, 202, 203, 204. In the illustrated embodiment, the cutting insert 200 has a total of four cutting edges 201, 202, 203, 204. However, it will be appreciated that the invention can be practiced with any desirable number of cutting edges. The cutting insert 200 also includes one or more coolant exit passageways 212, 222, 232, 242 and one or more coolant inlet passageways 211, 221, 231, 241 for the increased delivery of pressurized gaseous coolant, such as air, CO₂, and the like, to the insert-chip interface. In this embodiment, the one or more coolant exit passageways 212, 222, 232, 242 are located on the top side 208 of the cutting insert 200, and the one or more coolant exit passageways 211, 221, 231, 241 are located on the bottom side 207 and extend internally within the cutting insert 200 substantially parallel to the central, rotational axis 205 toward the top side 208. The one or more coolant exit passageways 212, 222, 232, 242 extend radially outward from a respective coolant inlet passageway 211, 221, 231, 241 toward a respective cutting edge 201, 202, 203, 204.

In the illustrated embodiment, the one or more coolant exit passageways 212, 222, 232, 242 and the one or more coolant inlet passageways 211, 221, 231, 241 are substantially circular in cross-sectional shape. However, it should be appreciated that the invention is not limited by the cross-sectional shape of the coolant exit passageways 212, 222, 232, 242 and the coolant inlet passageways 211, 221, 231, 241, and that the invention can be practiced with any desirable cross-sectional shape for effective delivery of coolant to the insert-chip interface. For example, the coolant exit passageways 212, 222, 232, 242 and the coolant inlet passageways 211, 221, 231, 241 can have any polygonal cross-sectional shape. In addition, the cross-sectional shape of the coolant exit passageways 212, 222, 232, 242 can be different than the cross-section shape of the coolant inlet passageways 211, 221, 231, 241. The cutting insert 200 also includes a centrally-located screw hole 206 for assisting in properly locating the cutting insert 200 when mounting the cutting insert 200 to a milling cutter body (not shown). In operation, the cutting insert 200 rotates about a central, rotational axis 205.

Similar to the drill heads 10, 40, 40, 100, each of the one or more coolant exit passageways 212, 222, 232, 242 of the cutting insert 200 have different dimensions (i.e., diameter and length) than each of the one or more coolant inlet passageways 211, 221, 231, 241. Specifically, each coolant exit passageway 212, 222, 232, 242 has an outer diameter, OD_exit, that is less than an outer diameter, OD_inlet, of each coolant inlet passageway 211, 221, 231, 241. In one embodiment, the outer diameter, OD_exit, of the coolant exit passageways 212, 222, 232, 242 is in a range between about 0.10 mm to about 1.00 mm. In one embodiment, for example, the range of the outer diameter, OD_exit, of the coolant exit passageways 212, 222, 232, 242 is between about 0.15 mm to about 0.30 mm.

In addition, the coolant exit passageway 43a has a length, L_exit, that is less than a length, L_inlet, of the coolant inlet passageway 44a. Similarly, the coolant exit passageway 43b has a length, L_exit, that is less than a length, L_inlet, of the coolant inlet passageway 44b. In the illustrated embodiment, the length, L_exit, of the coolant exit passageways 43a, 43b are substantially identical to each other. However, it will be appreciated that the invention can be practiced with one or more coolant exit passageways 43a, 43b have a length, L_exit, that is different with respect to one or more coolant exit passageways 43a, 43b.

In the illustrated embodiment, the outer diameter, OD_exit, of the coolant exit passageways 212, 222, 232, 242 are substantially identical to each other, and the outer diameter, OD_inlet, of the coolant inlet passageways 211, 221, 231, 241 are substantially identical to each other. However, it will be appreciated that the outer diameter, OD_exit, of one or more of the coolant exit passageways 212, 222, 232, 242 may have a different diameter with respect to the other coolant exit passageways 212, 222, 232, 242. Likewise, the outer diameter, OD_inlet, of one or more of the coolant inlet passageways 211, 221, 231, 241 may be different, so long as each of the coolant exit passageways 212, 222, 232, 242 have a smaller outer diameter than the coolant inlet passageways 211, 221, 231, 241.

It should be noted that in the cutting insert 200, there is a 1:1 ratio between the number of coolant exit passageways 212, 222, 232, 242 and the number of coolant inlet passageways 211, 221, 231, 241. However, it should be appreciated that the invention can be practiced with any desirable ratio between the number of coolant exit passageways 212, 222, 232, 242 and the number of coolant inlet passageways 211, 221, 231, 241.

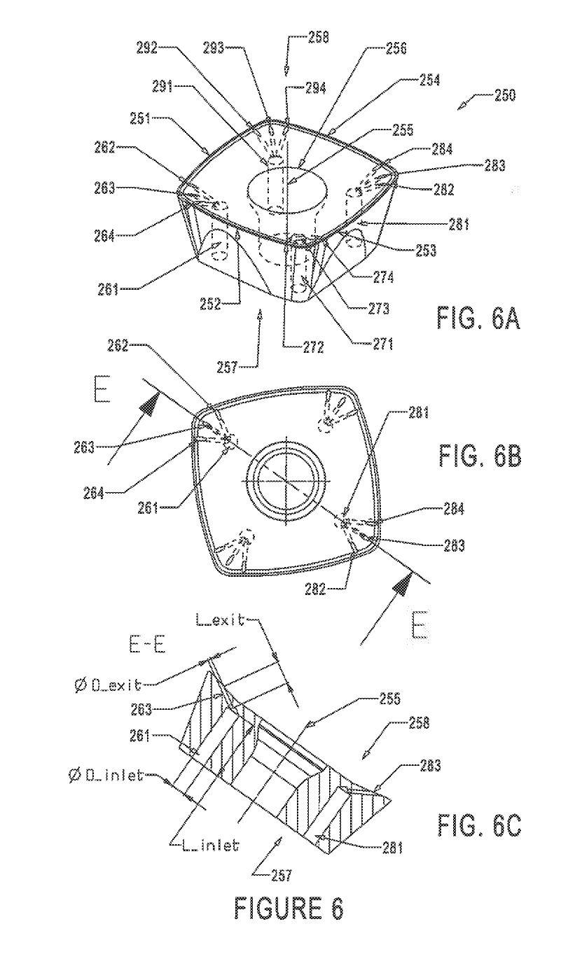

Referring now to FIGS. 6A-6C, a cutting insert 250 is shown according to another embodiment of the invention. In this embodiment, there is a 3:1 ratio (i.e., greater than 1:1) between the number of coolant exit passageways and the number of coolant inlet passageways. In other words, a single coolant inlet passageway 261 is in fluid communication with three coolant exit passageways, 262, 263, 264. Similarly, the coolant inlet passageway 271 is in fluid communication with three coolant exit passageways 272, 273, 274, the coolant inlet passageway 281 is in fluid communication with three coolant exit passageways 282, 283, 284, and the coolant inlet passageway 291 is in fluid communication with three coolant exit passageways 292, 293, 294. It will be appreciated that the invention can be practiced with any desirable ratio of coolant inlet passageways to coolant exit passageways, so long as the cutting insert provides a sufficient flow of coolant to the insert-chip interface.

Similar to the drill heads 10, 40, 40, 100 and the cutting insert 200, each of the one or more coolant exit passageways of the cutting insert 250 have different dimensions (i.e., diameter and length) than each of the one or more coolant inlet passageways. Specifically, each coolant exit passageway 262-264, 272-274, 282-284, 292-294 has an outer diameter, OD_exit, that is less than an outer diameter, OD_inlet, of each coolant inlet passageway 261, 271, 281, 291. In one embodiment, the outer diameter, OD_exit, of the coolant exit passageways 262-264, 272-274, 282-284, 292-294 is in a range between about 0.10 mm to about 1.00 mm. In one embodiment, for example, the range of the outer diameter, OD_exit, of the coolant exit passageways 262-264, 272-274, 282-284, 292-294 is between about 0.15 mm to about 0.30 mm.

In addition, the length, L_exit, of the coolant exit passageways 262-264, 272-274, 282-284, 292-294 is less than a length, L_inlet, of each coolant inlet passageway 261, 271, 281, 291. However, it will be appreciated that the invention can be practiced with one or more coolant exit passageways 262-264, 272-274, 282-284, 292-294 having a length, L_exit, that is different with respect to one or more other coolant exit passageways 262-264, 272-274, 282-284, 292-294.

In the illustrated embodiment, the outer diameter, OD_exit, of the coolant exit passageways 262-264, 272-274, 282-284, 292-294 are substantially identical to each other, and the outer diameter, OD_inlet, of the coolant inlet passageways 261, 271, 281, 291 are substantially identical to each other. However, it will be appreciated that the outer diameter, OD_exit, of one or more of the coolant exit passageways 262-264, 272-274, 282-284, 292-294 may have a different diameter with respect to the other coolant exit passageways 262-264, 272-274, 282-284, 292-294. Likewise, the outer diameter, OD_inlet, of one or more of the coolant inlet passageways 261, 271, 281, 291 may be different, so long as each of the coolant exit passageways 262-264, 272-274, 282-284, 292-294 have a smaller outer diameter than the coolant inlet passageways 261, 271, 281, 291.

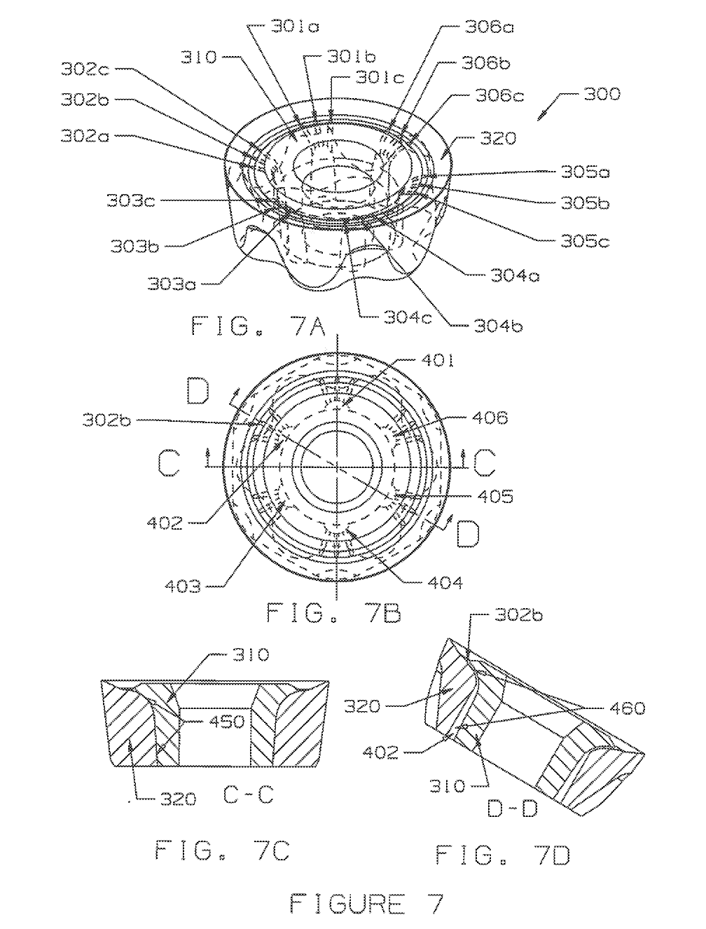

Referring now to FIGS. 7A-7D, a compound cutting insert 300 is shown according to another embodiment of the invention. The cutting insert 300 includes a core member 310 and a shell member 320. The points of contact between the core member 310 and the shell member 320 are securely joined together at a sealed interface 450 (FIG. 7C). The extent of the contact is sufficiently secure to be fluid-tight at the locations of contact. The extent of the contact is secure such that the core member 310 and the shell member 320 do not separate during usage.

The contact between the core member 310 and the shell member 320 can be through actual joinder of these components together. One can accomplish the joinder of the core member 310 and the shell member 320 by any one of a number of ways. For example, techniques such as, co-sintering, brazing and/or gluing are suitable. The specific technique may be particularly applicable to certain materials. For example, co-sintering may be applicable to a situation in which the core member and the shell member are of the same material (e.g., tungsten carbide-cobalt material). Gluing may be applicable to a situation in which the materials for the core member and the shell member are dissimilar (e.g., a steel core member and a tungsten carbide-cobalt base member). The contact can also be accomplished via compressing the component together while still maintaining theme to be separate and distinct from one another. For example, the cutting insert can be securely threaded to a tool holder (not shown), whereby there is a very strong surface-to-surface contact between the core member and the shell member due to the very tight connection between the cutting insert and the tool holder. When the components are compressed together via tightening of the cutting insert to the tool holder, these components may be separated upon detachment of the cutting insert from the tool holder.

The choice of specific materials for the components is dependent upon the particular applications for the cutting insert 300. The use of ceramic-ceramic or carbide-carbide or steel-carbide combinations of the components provides the cutting insert with a variety of material options. By doing so, the cutting insert has an expansive material selection feature that allows for optimum customization of the cutting insert from the materials perspective.

As is apparent, the components, and hence the cutting insert, 300 present a round geometry. By using a round geometry, the assembly of multiple components, e.g., a core and a shell, does not need indexing to accomplish. The absence of indexing or special alignment reduces the manufacturing costs and makes the assembly easier in contrast to components that require special alignment. This is especially the case for the core member. The core member has a generally cylindrical/conical geometry. It does not have exterior features that require special alignment or orientation in the assembly to the shell member. Thus, the assembly of the core member 310 to the shell member 320 is easy and inexpensive as compared to the assembly of components, each of which have complex geometric features.

The components, i.e., the core member 310 and the shell member 320 of the cutting insert 300 may be made from one of any number of materials that are suitable for use as a cutting insert. The following materials are exemplary materials useful for a cutting insert: tool steels, cemented carbides, cermets or ceramics. The specific materials and combinations of materials depend upon the specific application for the cutting insert. For example, the core member 310 and the shell member 320 may be made from different materials.

One aspect of the invention is that the cutting insert 300 includes one or more sets of interior coolant passageways. Specifically, the cutting insert 300 includes six sets of interior coolant passageways. A first set is defined by three coolant exit passageways 301a, 301b, 301c in fluid communication with a single coolant inlet passageway 401. A second set is defined by three coolant exit passageways 302a, 302b, 302c in fluid communication with a single coolant inlet passageway 402. A third set is defined by three coolant exit passageways 303a, 303b, 303c in fluid communication with a single coolant inlet passageway 403. A fourth set is defined by three coolant exit passageways 304a, 304b, 304c in fluid communication with a single coolant inlet passageway 404. A fifth set is defined by three coolant exit passageways 305a, 305b, 305c in fluid communication with a single coolant inlet passageway 405. A sixth set is defined by three coolant exit passageways 306a, 306b, 306c in fluid communication with a single coolant inlet passageway 406. For brevity, the following description of the second set of interior coolant passageways comprising the three coolant exit passageways 302a, 302b and 302c and the single coolant inlet passageway 402 is sufficient for a description of all such sets of interior coolant passageways.

In each one of the sets of interior coolant passageways, the open interface between the core member 310 and the shell member 320 define the boundaries of the coolant exit passageways 302a, 302b, 302c and the coolant inlet passageway 402. More specifically, the exterior surface of the core member 310 and the interior surface of the shell member 320 defines the coolant exit passageways 302a, 302b, 302c and the coolant inlet passageway 402.

As seen in FIG. 7D, it is apparent that the cross-sectional area of the coolant inlet passageway 402 changes along the axial length of the coolant inlet passageway 402. Specifically, the cross-sectional area of the coolant inlet passageway 402 is largest proximate the bottom surface of the cutting insert 300 and gradually tapers (i.e. decreases in cross-sectional area) along its axial length. In other words, the cross-sectional area of the coolant inlet passageway 402 is smallest proximate the coolant exit passageways 302a, 302b, 302c. Further, there should be an appreciation that the cross-sectional area can vary to achieve a specific desired flow configuration or spray pattern at the insert-chip interface. In this particular embodiment, the spray pattern is of a continuous nature to present a continuous cone of pressurized gaseous coolant in the vicinity of the insert-chip interface.

Similar to the earlier embodiments, each of the coolant exit passageways 302a, 302b, 302c have different dimensions (i.e., cross-sectional area and length) than each of the coolant inlet passageway 402. Specifically, the coolant exit passageways 302a, 302b, 302c have a cross-sectional area that is less than the cross-sectional area of the coolant inlet passageway 402.

Similar to the earlier embodiments, the length of each coolant exit passageway 302a, 302b, 302c is less than the length of the coolant inlet passageway 402. In the illustrated embodiment, the length of the coolant exit passageways 302a, 302b, 302c are substantially identical to each other. However, it will be appreciated that the invention can be practiced with one or more coolant exit passageways having a length that is different with respect to one or more other coolant exit passageways. Likewise, the coolant exit passageways 302a, 302b, 302c can have different cross-sectional areas. Similarly, the coolant inlet passageways 401, 402, 403, 405, 406 can have different cross-sectional areas and lengths, if desired.

As is apparent, the pressurized gaseous coolant enters the coolant inlet passageway 402, travels through the internal coolant inlet passageway 402, and into a respective coolant exit passageway 302a, 302b, 302c, and then exits via the coolant exit passageways 302a, 302b, 302c. Upon exiting the coolant exit passageways 302a, 302b, 302c, the pressurized gaseous coolant sprays toward the insert-chip interface. As the coolant follows the arcuate surface of the core member 310, the coolant drives toward the coolant exit passageways 302a, 302b, 302c in a radial outward direction. Thus, the coolant is flowing at the cutting edge as it exits the coolant exit passageways 302a, 302b, 302c. By flowing in a radial outward direction, the coolant better functions to flood the cutting edge in engagement with the workpiece. There should be an appreciation that the dispersion angle can range between about 10 degrees and about 60 degrees.

Because of the nature of the geometry of the coolant exit passageways 302a, 302b, 302c, the dispersion of coolant leads to a continuous spray of coolant. The continuous spray of coolant ensures that the insert-chip interface at the discrete cutting location experiences sufficient coolant flooding, and hence, sufficient coolant-caused cooling. As mentioned hereinbefore, a number of advantages exist due to the delivery of sufficient coolant to the insert-chip interface.

It is readily apparent that the different dimensions between the inlet and exit coolant passageways of the cutting insert of the invention increases the pressure and velocity of the coolant, thereby producing an increased streaming effect of the gaseous coolant to the insert-chip interface, which is the location on the workpiece where the chip is generated. By doing so, the cutting insert of the invention provides for increased delivery of coolant to the insert-chip interface so as to result in increased cooling at the insert-chip interface. The consequence of increased cooling at the insert-chip interface is a decrease in the tendency of the chip to stick to the cutting insert, as well as better evacuation of chips from the vicinity of the interface with a consequent reduction in the potential to re-cut a chip.

The patents and other documents identified herein are hereby incorporated by reference herein. Other embodiments of the invention will be apparent to those skilled in the art from a consideration of the specification or a practice of the invention disclosed herein. It is intended that the specification and examples are illustrative only and are not intended to be limiting on the scope of the invention. The true scope and spirit of the invention is indicated by the following claims.

What is claimed is:

1. A cutting insert, comprising:
at least one internal coolant inlet passageway having a first cross-sectional area; and
at least one internal coolant exit passageway having a second cross-sectional area, the at least one internal coolant exit passageway in fluid communication with the at least one internal coolant inlet passageway,
wherein coolant enters the at least one internal coolant inlet passageway at a first surface of the cutting insert and exits the at least one coolant exit passageway at a second, different surface of the cutting insert, and
wherein the second cross-sectional area of the at least one internal coolant exit passageway are at least two times less than the first cross-sectional area of the at least one internal coolant inlet passageway, thereby producing an increased streaming effect of the coolant to an insert-chip interface.

2. The cutting insert according to claim 1, wherein the at least one internal coolant exit passageway and the at least one internal coolant inlet passageway have a circular cross-sectional shape.

3. The cutting insert according to claim 2, wherein an outer diameter, OD_exit, of the at least one internal coolant exit passageway is in a range between about 0.10 mm to about 1.00 mm.

4. The cutting insert according to claim 3, wherein the outer diameter, OD_exit, of the at least one internal coolant exit passageway is in a range between about 0.15 mm to about 0.30 mm.

5. The cutting insert according to claim 2, wherein the second cross-sectional area of the at least one internal coolant exit passageway is at least 3-10 times smaller than the first cross-sectional area of the coolant inlet passageways 14a, 14b.

6. The cutting insert according to claim 1, wherein the at least one internal coolant exit passageway has a varying cross-sectional shape.

7. The cutting insert according to claim 1, wherein a ratio of a number of internal coolant exit passageways to a number of internal coolant inlet passageways is 1:1.

8. The cutting insert according to claim 1, wherein a ratio of a number of internal coolant exit passageways to a number of internal coolant inlet passageways is greater than 1:1.

9. The cutting insert according to claim 1, wherein the cutting insert comprises a replaceable carbide drill head.

10. The cutting insert according to claim 1, wherein the cutting insert comprises an indexable carbide milling cutting insert.

11. The cutting insert according to claim 1, wherein the cutting insert comprises an indexable carbide turning cutting insert.

12. The cutting insert according to claim 1, wherein the cutting insert comprises a compound cutting insert.

13. The cutting insert according to claim 12, wherein the cutting insert comprises a core member and a shell member, and wherein the at least one internal coolant exit passageway and the at least one internal coolant inlet passageway is formed at an open interface between the core member and the shell member.

14. The cutting insert according to claim 13, wherein the core member is made of a first material and the shell member is made of a second material.

15. The cutting insert according to claim 14, wherein the first material is the same as the second material.

16. The cutting insert according to claim 14, wherein the first material is different than the second material.

17. The cutting insert according to claim 1, wherein the at least one internal coolant exit passageway extends radially outward with respect to the at least one internal coolant inlet passageway.

18. A cutting insert comprising a plurality of internal coolant passageways, each internal coolant passageway comprising a circular coolant inlet passageway and a circular coolant exit passageway, wherein a diameter of each circular coolant exit passageway is at least two times smaller than a diameter of the circular coolant inlet passageway, thereby producing an increased streaming effect of the coolant to an insert-chip interface.

19. The cutting insert according to claim 18, wherein the circular coolant exit passageway is in the form of one of a straight cylindrical passageway and a tapered cylindrical passageway.

20. The cutting insert according to claim 18, wherein an outer diameter, OD_exit, of the circular coolant exit passageway is in a range between about 0.10 mm to about 1.00 mm.

21. The cutting insert according to claim 20, wherein the outer diameter, OD_exit, of the circular coolant exit passageway is in a range between about 0.15 mm to about 0.30 mm

22. The cutting insert according to claim 18, wherein a ratio of a number of circular coolant exit passageways to a number of circular coolant inlet passageways is 1:1.

23. The cutting insert according to claim 18, wherein a ratio of a number of circular coolant exit passageways to a number of circular coolant inlet passageways is greater than 1:1.

24. The cutting insert according to claim 18, wherein the cutting insert comprises a replaceable carbide drill head.

25. The cutting insert according to claim 18, wherein the cutting insert comprises a compound cutting insert.

26. The cutting insert according to claim 18, wherein the cutting insert comprises an indexable carbide milling cutting insert.

27. The cutting insert according to claim 18, wherein the cutting insert comprises an indexable carbide turning cutting insert.
